(19) United States
(12) Patent Application Publication
(10) Pub. No.: US 2020/0022354 A1
(43) Pub. Date: Jan. 23, 2020

(54) FLYING INSECT EXTERMINATOR

(71) Applicant: Roger Beaudoin, Edson (CA)

(72) Inventor: Roger Beaudoin, Edson (CA)

(21) Appl. No.: 16/040,209

(22) Filed: Jul. 19, 2018

(51) Int. Cl. A01M 1/10; A01M 1/22; A01M 5/04

(52) U.S. Cl. CPC A01M 1/106; A01M 5/04; A01M 1/223

(57) ABSTRACT

A mobile system for exterminating insects includes a transportable mobile frame with a conveyance device mounted to the frame, a plate mounted adjacent to an opening to the conveyance device, and a liquid supply and distribution system configured to apply a volume of liquid on a surface of the plate and thereby wet the surface of the plate. The opening to the conveyance device receives insects that are demobilized by contact with the wetted surface of the plate and fall into the conveyance device. The conveyance device exterminates the demobilized insects and conveys the exterminated insects toward a discharge from the mobile system. A motorized vehicle such as a tractor with a tow bar system can pull the mobile system across an open field. In at least one embodiment, insects are exterminated through mechanical means without the use of electrocution.

### BACKGROUND

### Technical Field

This disclosure relates to a system for exterminating insects through mechanical means.

### Description of the Related Art

Previous methods and systems for extermination of flying insects and insects such as grasshoppers and crickets relied on the application of chemical insecticides or systems based on electrocution.

Various systems to exterminate pests through mobile devices and electrocution have been developed as described by Walter Kemp in U.S. Pat. No. 1,325,475, William Harwood in U.S. Pat. No. 1,624,240, Oscar Ekre in U.S. Pat. No. 2,029,225, Walter Bialobrzeski in U.S. Pat. Nos. 3,758,980 and 3,846,932, and Kenneth Podgurney in U.S. Pat. No. 6,718,690. Improved methods and equipment for insect extermination are needed.

### BRIEF SUMMARY

The present disclosure is directed to new and improved mobile systems and methods for extermination of insects. While features including electrocution of insects may optionally be included, use of electrocution is not required. In at least one embodiment, a clear liquid distributor system is mounted on top of a clear plate that is mounted on top of a power driven auger (conveyance device). The power driven auger is mounted on a transportable mobile frame for movement over ground. A motorized vehicle such as a tractor with a tow mechanism such as a conventional tow bar can pull the assembled system across an open field.

The assembled system includes a liquid (such as water or light oil or equivalent) distributor system with a liquid supply system (tank) and a liquid pump. The liquid distributor system applies a volume of liquid, preferably an adjustable volume of clear liquid, on the front and/or back surface of the clear plate. Flying insects, such as grasshoppers and other bugs, that contact the wetted clear plate are demobilized and fall into an opening of the power driven auger and are contained and exterminated. The bodies of the wetted flying insects are conveyed with liquid down the auger to a liquid filter and pump that extracts any free liquid, filters the free liquid, and returns the filtered liquid back to the liquid supply system. The liquid filter may include, for example, a conventional replaceable cartridge suitable for filtering the liquid. The flying insect bodies then pass through a chopping device to finally exterminate the insect and chop/shred the insect bodies into small pieces, which are then discharged directly to the outside ground. In some embodiments, one or more energized wires may be positioned in or near the auger to electrocute the insect, which may then optionally be chopped by the chopping device. The exterminated insect bodies are then discharged to the outside ground and act as a natural organic fertilizer. No collection of the exterminated insect bodies for later disposal is required.

The assembled system also includes a power supply (AC or DC) that provides necessary electrical power to the liquid pump and/or the power driven auger (conveyance device). Alternatively, the power supply can be provided by the motorized vehicle power system, other vehicle accessories (such as a power take off), or hydrocarbon fueled, wind, or solar power supply system.

Multiple assembled systems according to the present disclosure can be linked together and pulled jointly across an open field, according to the needs of the operator.

### BRIEF DESCRIPTION OF THE SEVERAL VIEWS OF THE DRAWINGS

There will now be described preferred embodiments of the disclosure, with reference to the drawings, by way of illustration only and not with the intention of limiting the scope of the disclosure, in which like numerals denote like elements and in which:

FIG. 1 is a block diagram of illustrating parts and components of a system according to an embodiment of the present disclosure;

FIG. 2A is a top view of a clear plate and auger assembly;

FIG. 2B is a side view of the clear plate and auger assembly with a clear liquid distributor assembly;

FIG. 2C is another side view of the clear plate and auger assembly and the clear liquid distributor assembly;

FIG. 3A is a partial isometric view of the clear plate and auger assembly; and

FIG. 3B is another partial isometric view of the clear plate and auger assembly.

### DETAILED DESCRIPTION

In this patent document, the word “comprising” is used in its non-limiting sense to mean that items following the word in the sentence are included and that items not specifically mentioned are not necessarily excluded. The use of the indefinite article “a” in the claims before an element means at least one of the element is specified, but does not specifically exclude others of the element also being present, unless the context clearly requires that there be one and only one of the element.

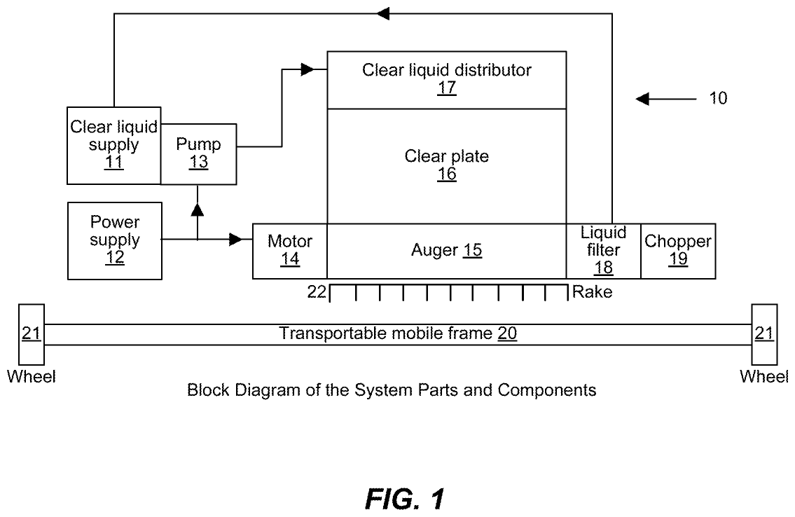

Referring to FIG. 1, an insect exterminator system 10 is comprised of a clear liquid distributor system 17 mounted on top of a plate 16, preferably a clear plate, which is mounted on top of an auger (conveyance device) 15 that is mounted on a transportable mobile frame 20 with wheels 21 for movement over ground. The mobile frame 20 may be vertically adjusted so that the height of the system 10 can be varied according to ground conditions. The exterminator system 10 may also include a rake 22 mounted on a leading edge of the mobile frame 20 to disturb the flying insects in an open field as the system 10 passing through the field. A motorized vehicle such as a tractor with a conventional tow bar can pull the exterminator system 10 across the open field.

The exterminator system 10 further includes a liquid supply system (tank) 11 and liquid pump 13 for pumping liquid onto the outer surfaces of the clear plate 16. The liquid is preferably a clear liquid such as water or light oil or the like. The clear liquid distributor system 17 applies a volume of the clear liquid over the front and/or back surface of the clear plate 16. Flying insects, such as a grasshopper, that contact the wetted front and/or back surfaces of the clear plate 16 are demobilized by the liquid and fall into an opening of the auger 15 and are contained and exterminated. A power motor 14 is operably connected to the auger 15 to drive the auger. The wetted flying insect bodies are preferably conveyed by the auger 15 to a liquid filter and pump 18 to extract any free liquid. The liquid filter 18 filters the free liquid and pumps the filtered liquid back to the clear liquid supply system (tank) 11. The liquid filter 18 may be comprised of a conventional replaceable cartridge suitable for filtering the liquid. While the auger 15 may be a rotating screw, in other embodiments the auger 15 may utilize a pressurized pneumatic or pressurized liquid as a propulsion force, in addition to or in place of a rotating screw, to convey the wetted insect bodies down the auger 15 toward the filter 18 and discharge from the system. The motor 14 may include a pneumatic or liquid propulsion system that provides the pressurized pneumatic or liquid propulsion force.

In at least one embodiment, the filtered (and possibly dried) insect bodies then pass through a chopping device 19 to finally exterminate the insects that are not already dead and cut/chop/shred the insect bodies into small pieces, which are then discharged directly to the outside ground. The exterminated cut/chopped/shredded insect bodies that are discharged to the ground act as a natural organic fertilizer. Collection and later disposal of the exterminated insect bodies is not required.

The system 10 further includes a power supply system 12 (which in some embodiments may be an AC or DC electrical power supply, depending on system requirements) to provide necessary electrical power to the liquid pump 18 and to power the motor 14 that drives the auger 15. The power supply system 12 may alternatively be provided by a power system of the motorized vehicle that is transporting the frame 20 through the open field, other vehicle accessories (such as a power take off), or a hydrocarbon fueled, wind, or solar powered power supply.

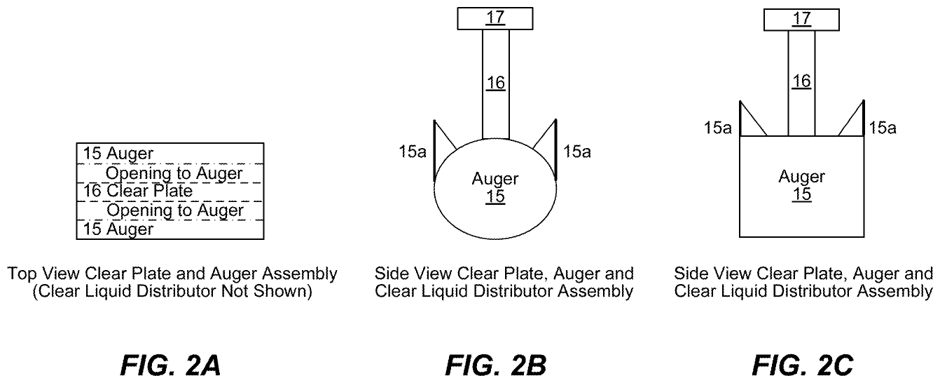

Referring to FIG. 2A, the clear plate 16 is vertically mounted above the auger 15, and preferably on the top centerline of the auger 15. On each side of the clear plate 16 where the plate is mounted, a suitable opening to the auger 15 is made to allow demobilized insects to fall from the plate into the auger. The openings on each side of the auger 15 are preferably equipped with a suitable removable personnel safety guard.

Referring to FIG. 2B, the clear liquid distributor 17 is mounted on top of the clear plate 16 and provides a volume of liquid, preferably an adjustable volume of clear liquid, over the front and/or back surface of the clear plate 16. In this regard, the liquid distributor 17 may use one or more nozzles to spray the liquid on the front and/or back surfaces of the plate 16. Alternatively, the liquid distributor 17 use a drip system to distribute liquid on the front and/or back surfaces of the plate 16. When flying insects, such as grasshoppers, contact the wetted clear plate, the insects are demobilized and fall or slide down the plate into the opening(s) of the auger 15 and are contained and exterminated as described herein. The openings on each side of the auger 15 are equipped with suitable deflector plates 15a to guide the demobilized insects through the opening into the auger 15.

The auger 15 may have any suitable cross-sectional shape. Referring to FIG. 2C for example, the auger 15 is shown as being a device with a square or rectangular cross-section, though a circular or other cross-sectional shape as shown in FIG. 2B may be employed.

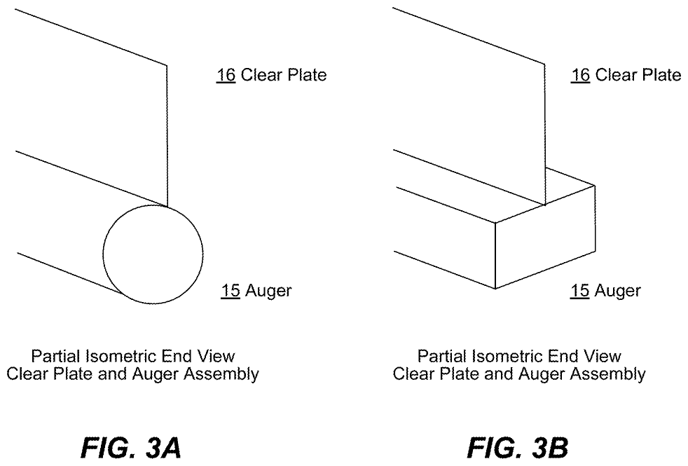

Referring to FIG. 3A, the auger 15 and the clear plate 16 are shown in a partial isometric view to aid in the clarity of this description. In FIG. 3A, the auger 15 has a circular cross-section while in FIG. 3B, the auger 15 alternatively has a square or rectangular cross-section. The auger 15 may use any suitable mechanism, e.g., a screw or belt, or use gravitational flow or other forced propulsion, to convey the insect bodies that fall from the plate 16 into the auger.

It should be appreciated that other embodiments of the exterminator system 10 may include one or more energized wires positioned in or near the auger to electrocute the demobilized insects, which are then optionally chopped by the chopping device prior to discharge from the mobile system. It should also be appreciated that multiple exterminator systems 10 may be mechanically linked together and jointly pulled across an open field as required by the operator.

Immaterial variations may be made to the embodiments described here without departing from the essence of the disclosure. The various embodiments described above can be combined to provide further embodiments.

All of the U.S. patents referred to in this specification are incorporated herein by reference in their entirety. Aspects of the foregoing embodiments can be modified, if necessary to employ concepts of the various patents to provide yet further embodiments.

These and other changes can be made to the foregoing embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A mobile system for exterminating insects in a field without the use of electrocution, the mobile system comprising:
a transportable mobile frame configured for movement over a ground surface of the field;
a power driven conveyance device mounted on the frame;
a plate having a front and back surface, wherein the plate is mounted on top of the power driven conveyance device adjacent to an opening to the conveyance device;
a liquid supply system including a tank and liquid pump; and
a liquid distribution system coupled to the liquid pump,
wherein the liquid pump is configured to pump liquid from the tank to the liquid distribution system, and the liquid distribution system is configured to apply a volume of liquid on the front and/or back surface of the plate and thereby wet the plate surface,
wherein the opening to the conveyance device is configured to receive insects that are demobilized by contact with the wetted plate and fall into the conveyance device, and
wherein the conveyance device is configured to convey the demobilized insects toward a discharge from the mobile system.

2. The mobile system of claim 1, wherein the conveyance device is an auger.

3. The mobile system of claim 1, wherein the conveyance device has a circular, square, or rectangular cross-section.

4. The mobile system of claim 1, further comprising a chopping device, wherein the conveyance device conveys the demobilized insects to the chopping device which chops the bodies of the insects prior to discharge of the chopped insect bodies from the system.

5. The mobile system of claim 1, further comprising a liquid filter coupled to the conveyance device, wherein the liquid filter is configured to filter liquid in the conveyance device and return filtered free liquid to the liquid supply system.

6. The mobile system of claim 5, wherein the liquid filter is a replaceable cartridge configured for filtering the liquid in the conveyance device.

7. The mobile system of claim 1, wherein the liquid is a clear liquid.

8. The mobile system of claim 6, wherein the clear liquid is water or a light oil.

9. The mobile system of claim 1, wherein the plate is a clear plate.

10. The mobile system of claim 1, wherein the liquid distribution system is mounted on top of the plate.

11. The mobile system of claim 1, wherein the liquid distribution system is configured to apply an adjustable volume of liquid on the front and/or back surface of the plate.

12. The mobile system of claim 1, further comprising a rake configured to disturb the insects in the field as the system is transported through the field.

13. The mobile system of claim 1, wherein the liquid supply system is configured to apply an adjustable volume of liquid over the front and/or back surface of the plate.

14. The mobile system of claim 1, wherein the conveyance device utilizes a pressurized pneumatic or liquid propulsion to convey the demobilized insects toward the discharge.

15. The mobile system of claim 1, further comprising a power supply system that provides power to the liquid pump and power driven conveyance device, wherein the power supply system is couple able to a power system of a motorized vehicle utilized to transport the mobile frame over the ground surface of the field.

16. The mobile system of claim 15, wherein the motorized vehicle is a tractor with a tow bar system configured to pull the mobile system across the field.

17. The mobile system of claim 1, wherein the mobile system is coupleable to one or more additional mobile systems according to claim 1 that can be jointly pulled across the field.

18. A mobile system for exterminating insects, the mobile system comprising:
a transportable mobile frame with a conveyance device mounted to the frame;
a plate mounted adjacent to an opening to the conveyance device; and
a liquid supply and distribution system configured to apply a volume of liquid on a surface of the plate and thereby wet the surface of the plate,
wherein the opening to the conveyance device is configured to receive insects that are demobilized by contact with the wetted surface of the plate and fall into the conveyance device, and
wherein the conveyance device is configured to exterminate the demobilized insects and convey the exterminated insects toward a discharge from the mobile system.

19. The mobile system of claim 18, further comprising one or more energized wires positioned in or near the auger, whereby demobilized insects are exterminated by electrocution.

20. The mobile system of claim 18, wherein the liquid supply and distribution system includes a liquid pump configured to pump liquid from a tank of liquid to one or more nozzles that apply the volume of liquid to a surface of the plate.

21. The mobile system of claim 18, further comprising a liquid filter coupled to the conveyance device, wherein the liquid filter is configured to filter liquid in the conveyance device and return filtered free liquid to the liquid supply and distribution system.
